(19) United States
(12) Patent Application Publication
(10) Pub. No.: US 2006/0011592 A1
(43) Pub. Date: Jan. 19, 2006

(54) Laser welding control

(76) Inventors: Pei-Chung Wang, Troy, MI (US); Hai-Lung Tsai, Rolla, MO (US); Yueh-Se J. Huang, Ann Arbor, MI (US); Phillip M. Turner, Grand Blanc, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/894,414

(22) Filed: Jul. 14, 2004

(51) Int. Cl. B23K 26/24; B23K 26/03

(52) U.S. Cl. 219/121.64; 219/121.62; 219/121.83

(57) ABSTRACT

In laser welding of metallic workpieces, the energetic beam is moved over the workpiece surface to form a pool of molten weld metal that quickly solidifies behind the advance of the laser into a weld nugget. The laser beam produces a keyhole of plasma-containing vapor within the molten pool. Weld nugget porosity, due to entrapment of the vapor, is minimized by continually sensing radiation from the molten metal pool to determine pool depth and width and then controlling laser power and speed to continually produce a weld metal pool wide enough for the liquid to fully expel the vapor and solidify into a pore free nugget.

### TECHNICAL FIELD

This invention pertains to control of laser welding power, focal point and the speed of advancement of a laser welding beam to produce pore free welds. More specifically, this invention pertains to sensing and determining the depth and width of the molten weld metal pool produced by the laser beam for such welding control.

### BACKGROUND OF THE INVENTION

The use of laser welding in the manufacture of automotive vehicle bodies and components offers higher process speeds, better precision of weld location and smaller heat affected zones. A powerful laser beam can be accurately focused on the surface of a metal workpiece and moved in a predetermined weld path to continuously form a molten pool of weld metal that re-solidifies to a weld nugget. For example, CO₂ and Nd:YAG lasers have been used in these applications. In automobile manufacturing ferrous or aluminum alloy parts are joined by this practice.

The highly coherent, focused and energetic laser beam strikes the workpiece surface and melts the metal in a relatively deep and narrow trench-like cross-sectional pattern to a depth suitable for joining, for example, overlapping layers of sheet metal. As the beam moves along its directed path the molten metal dissipates its heat to the unheated surrounding metal and solidifies into a strong weld nugget that metallurgically bonds adjacent surfaces. The laser beam can be focused so that the heat effect on surrounding metal is limited.

A difficulty in such a continuous laser welding process is that the weld nugget may contain porosity which can weaken it. It is an object of this invention to provide a method of sensing, determining and controlling the depth and width of the weld pool so as to minimize or eliminate such porosity. It is a further object of the present invention to use data, sensed from light radiated from the weld site, for determining the depth and width of the weld metal pool to control laser operation to reduce weld porosity.

### SUMMARY OF THE INVENTION

When a laser beam of sufficient power is directed at and moved along the surface of a sheet metal workpiece, metal is temporarily melted along the path of the advancing beam. The depth of the molten material below the workpiece surface depends largely on the penetrative energy of the beam and duration of exposure. The width of the body of molten material also depends on these energy and time factors and the focus of the beam. The laser radiation also produces a “keyhole” within the molten mass. The keyhole is a Gaussian-like shaped hole, in cross-sectional view, filled with metal vapor and plasma and is surrounded with molten metal. As the high intensity laser beam interacts with the workpieces, a high “recoil pressure” is generated. This recoil pushes the molten metal downward and squeezes the molten metal upward along the keyhole walls. Hence, part of the molten metal is accumulated at the top portion of the keyhole and the rest of the molten metal forms the sides and bottom of the keyhole. When the laser beam is removed (moves), the existing keyhole tends to collapse due to gravity. The molten metal in the top and side portions of the keyhole tends to backfill the keyhole. However, as soon as the laser beam is removed, molten metal also starts to solidify by heat conduction to the surrounding metal of the workpiece.

There are two competing processes: (1) the molten metal backfill speed, and (2) the molten metal re-solidification speed. A “pore” will be formed near the root of the keyhole if molten metal solidifies before the keyhole is filled. On the other hand, if the molten metal lining the vapor keyhole can fill the keyhole before the molten metal re-solidifies, no pore remains. The outcome of the competing processes depends on the aspect ratio of the keyhole and the molten metal that lines it (depth to width ratio). For a keyhole with a high depth-to-width ratio the molten metal surrounding the top portion of the keyhole may not have enough time to backfill the keyhole before the molten metal solidifies and traps un-displaced vapor or plasma as one or more pores.

The focused laser beam produces a seam of molten metal that is deep and narrow in the workpiece surface and traces the path of the beam. This invention recognizes that the width (or cross-sectional diameter) of the molten weld pool, including keyhole space, must be sufficient to backfill the keyhole and allow the potential keyhole pore to be filled. Thus, this method continually determines the depth of the keyhole and molten metal pool and the width of the keyhole and pool at the workpiece surface as the laser beam advances. This data is used to control laser operating parameters to maintain a ratio of weld pool depth to width suitable to obtain a pore free weld nugget. This ratio, termed the weld pool aspect ratio in this specification, is to be sufficiently low to permit the backfill of the keyhole before the molten metal solidifies. In other words, it is found that when the weld pool is too deep and narrow, the keyhole cannot be filled in time.

In the set-up of a laser welding assembly operation, workpiece material and size is selected. These selections have a significant effect on the rate of heat transfer from the weld site. For example, two overlapping pieces of aluminum alloy sheet material, each one millimeter thick, may be assembled for the formation of a weld nugget by laser beam welding. A suitable weld penetration into the aluminum sheets is then determined to obtain a desired mechanical strength for the weld. Welding process variables are then determined or selected. These variables include the power of the laser beam, its focal point size and shape, and the speed with which the beam traverses the workpiece. Thus, for example, a CO₂ laser at a two kilowatt power level may be focused in a circular beam of about 0.8 millimeter diameter. A flow of a gas mixture, serving as a protective atmosphere, is directed at the weld site as the laser beam traverses the workpiece in the welding operation.

In accordance with the invention, the welding parameters are continually managed so as to consistently produce a weld pool aspect ratio so that the molten metal backfills the keyhole and solidifies without internal pores. The ratio of the depth of the narrow trench of molten metal momentarily produced by the laser to the width of the molten material at the surface of the workpiece must be suitably low before the melt re-solidifies. A suitable aspect ratio range may be predetermined during set-up of the welding process parameters. But in the practice of this invention, current values of weld pool width (or diameter) and depth are tracked during welding so as to maintain a predetermined aspect ratio. The tracking is permitted by electromagnetic emissions and sonic emissions from the metal vapor containing keyhole.

The keyhole at a weld site is temporarily sustained by the evaporation of metal from the weld pool. The outward flow of metallic vapor from the keyhole produces acoustic waves. Plasma is formed within and above the keyhole by ionization of the shielding gas and the metallic vapor. A primary signal from the weld pool is infrared radiation from the hot weld pool. The plasma itself produces visible and ultraviolet radiation, and the acoustic waves. Methods have been developed and previously used to monitor weld pool depth based on one or more of these signals. For purposes of the practice of the invention, the width of the weld pool can be suitably detected by mapping the infrared radiation from the surface of the pool.

In accordance with a preferred embodiment of the invention, a suitable mirror-containing optical system is used to direct the laser beam perpendicularly at the intended weld site. Radiation from the plasma in the keyhole may be gathered using the same optics and directed to a suitable sensor for information concerning the depth of the metal pool. Separately, a camera, or other suitable sensor, with a filter passing infrared radiation from the surface of the weld pool is used to determine the present width of the molten weld metal pool. A computer control system continually compares the current instantaneous ratio of pool depth to width with the pre-determined range and, if necessary, adjusts one or more of weld beam focus, power or speed to maintain a desired balance of pool depth and with for good pore-free welds.

Other objects and advantages of the invention will become more apparent from a detailed description of preferred embodiments which follows.

### BRIEF DESCRIPTION OF THE DRAWINGS

FIG. 1 is a schematic view of a laser welding set-up for producing a seam weld between overlapping metal alloy strips or plates. The figure illustrates imaging means for detecting the depth and width of the laser beam produced molten metal pool for computer control of the welding process.

FIG. 2 is a cross-sectional view of a keyhole/weld pool site in the overlapping strips at location and direction 2-2 of FIG. 1.

FIGS. 3A-3F are computer-model generated graphs illustrating porosity formation in laser weld nuggets as a function of the depth-to-diameter ratio (molten metal pool aspect ratio). In each figure the x-axis is the diameter (2 times r) in millimeters of the pool and the y-axis is the depth (z) in mm of the pool. FIGS. 3A-3C illustrate the decreasing possibility of pore formation as pool depth is decreased in welding examples of constant pool diameter, i.e. as the pool aspect ratio is decreased. FIGS. 3D-3F illustrate the decreasing possibility of pore formation as the pool aspect ratio is progressively decreased in welding examples of constant pool depth.

FIG. 4 is a process flow diagram for a computer executed process of performing laser welds while continually determining the aspect ratio of the molten metal pool and using the measured aspect ratio in control of the laser power and welding speed.

### DESCRIPTION OF PREFERRED EMBODIMENTS

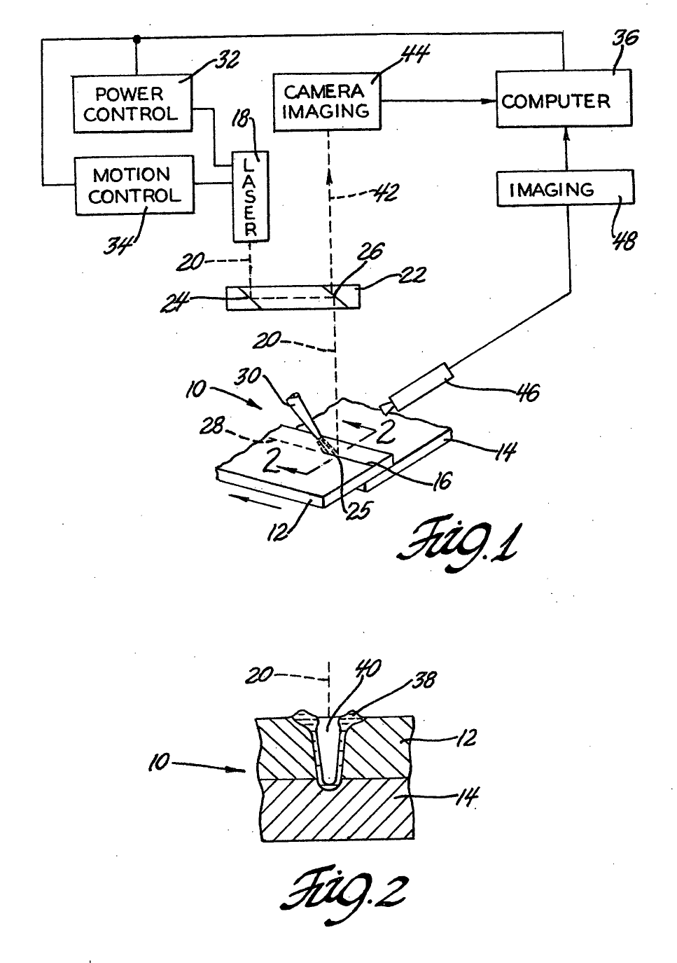

In FIG. 1 an assembly 10 of overlapping metal sheets 12, 14 is prepared for joining by laser welding. Metal sheets 12, 14, which may be sheets of aluminum alloy, are illustrated as fragments only of overlapping workpieces intended to be joined by a continuous weld seam 16.

The energy for the formation of weld seam 16 is provided by a commercial laser 18 such as, for example, a CO₂ laser or an Nd:YAG laser of suitable power. In this example, a coherent high energy CO₂ laser beam 20 from laser 18 is passed through an optical system 22 which redirects beam 20 at the advancing weld site 25, at the end of weld seam 16. Optical device 22 includes a first mirror 24 and a second mirror 26 for reflecting and directing of the laser beam 20.

In this welding application, laser beam 20 is continually moved in a known manner along the surface of sheet 12 in the path indicated at 28 until the weld seam 16 traverses the region of overlap of sheets 12 and 14. Also focused at the advancing weld site 25 is a gas nozzle 30 at the end of a gas delivery line, not shown. Nozzle 30 directs a mixture of shielding gases at the weld site. The shielding gas mixture may suitably comprise helium, nitrogen, and argon to prevent oxidation of the molten metal forming the weld. Laser device 18 also includes a suitable power control system 32 and a suitable motion control system 34 which are known and available. In the practice of this invention the power level of the laser and its motion are managed by suitably programmed computer 36 in a manner which will be described.

Referring briefly to FIG. 2, the effect is seen of laser beam 20 at the moment of its impact at the weld site on the fragmentary section of sheets 12 and 14. The high energy photons of the laser beam 20 produce molten metal 38 and a mixture of metal vapor and plasma material that cause the formation of keyhole 40. The cross-sectional profile of keyhole 40 is momentarily sustained by the pressure of the just-generated metal vapor and plasma which forces the molten metal 38 into the generally U-shaped (Gaussian-like) profile seen in the cross-sectional view of FIG. 2. As illustrated, the total depth of keyhole 40 and surrounding molten metal layer 38 extends through sheet 12 and into the sheet 14 so that when the molten metal 38 fills the keyhole space 40 and forms a weld nugget, the nugget suitably penetrates into sheet 14 to bond it to sheet 12. Thus, FIG. 2 is a cross-sectional view that shows the momentary presence of metal vapor/plasma keyhole 40 and the displaced molten metal 38. As laser beam 20 is advanced along the weld path 28, the heavier molten metal 38 will flow into and displace the gaseous material that is shaping keyhole 40.

Referring again to FIGS. 1 and 2, the plasma material and molten metal vapor in keyhole 40 generate infrared and ultraviolet electromagnetic radiation which emanates from the weld site. The sudden temperature increase also affects the surrounding air and produces acoustical waves. One path of the radiation is back up along the direction of laser beam 20 and this radiation may be passed through semi-reflecting mirror 22 upward along path 42 through a suitable focusing lens, not shown, to a camera imaging device 44 or other suitable detection means (e.g., a photodiode) for receiving and measuring the quantity of radiation emanating from keyhole 40. The intensity of this radiation is compared with baseline radiation data from known good weld sites in a data acquisition system to determine the depth of keyhole 40. This technology is known to those skilled in the art and accordingly, imaging device 44 and programmed computer 38 can be used to reliably estimate the depth of keyhole 40 plus the molten metal layer 38 at a given instance at a weld site. Computer 36 processes this radiation data for the purpose of managing the power of laser 18 and its rate of movement across the intended weld path 28.

A suitable microphone can be used to detect the acoustical response of the heated air at the weld site. This information can be compared with baseline data from known good welds instead of, or to supplement, the radiation from the keyhole 40 and metal 38.

Similarly, the infrared radiation from the weld site may be sensed and compared with baseline data from known good weld sites to determine the width of the keyhole 40 and molten metal pool 38 at the surface of the weld site 25. The infrared radiation is detected by a camera 46 with suitable IR sensors and the radiation is imaged by sensing device 48 to measure the diameter or the width of the molten metal pool 38 at the weld site. Likewise, this information concerning the width of the weld pool 38 may be used in controlling the power control of the laser and the motion of the commercial laser 18.

Thus, there are known sensing procedures and equipment for reliably estimating the depth and width of the molten metal/keyhole and this capability is used in the on-the-run welding control process of this invention.

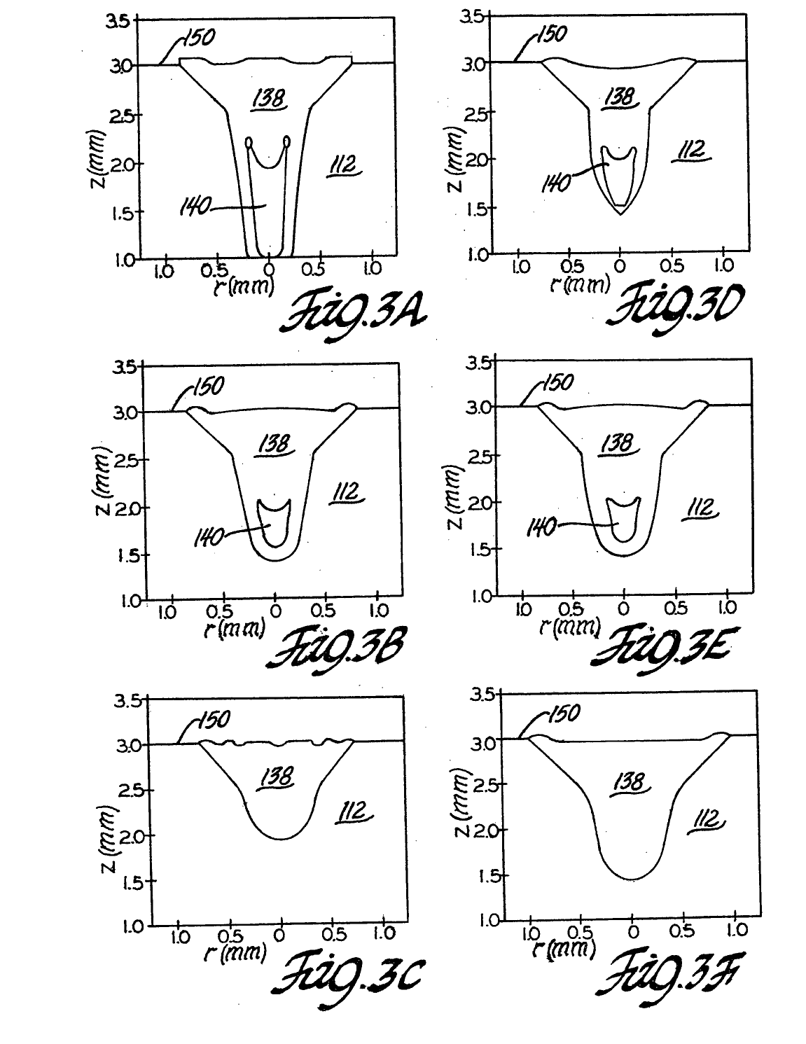

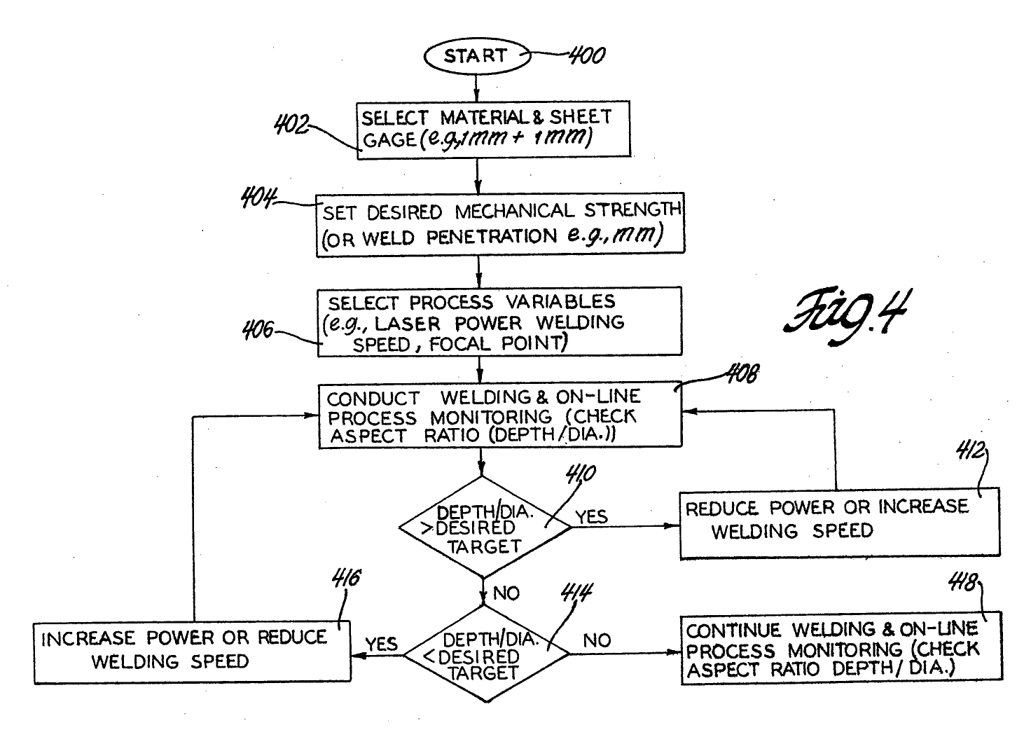

As stated, the process of this invention is based on managing the width of the molten metal pool and the depth of the molten metal pool in an ongoing laser beam welding operation so as to avoid the formation of pores in the completed weld nugget. FIGS. 3A-3F are a series of computer generated graphs reflecting the cross-section of a weld site in a workpiece 112. A laser beam has produced a mass of molten metal which in FIGS. 3A-3F has solidified to form a weld nugget 138. The laser beam also produced a keyhole of metal vapor and metal plasma, a portion of which is seen trapped as a pore 140 within nugget 138 in FIGS. 3A, 3B, 3D and 3E.

The x-axis of these six figures reflects dimensions in millimeters from the center of weld nugget 138 outward to its furthest reach at the surface 150 of workpiece 112, i.e. the radius, r, of the top of the nugget. Thus, 2×r equals the width or diameter of the weld nugget at the surface of the workpiece. The y-axis represents a distance up from a datum below each figure up to the surface 150 of workpiece 112. The y-axis is used to determine the depth of the weld nugget 138.

In FIGS. 3A-3C, the width of the original keyhole/molten metal pool, as approximated and evidenced by the width of weld nugget 138, is constant and the width or diameter is about 1.7 mm. But the depth of the molten metal pool varies from more than 2 mm in FIG. 3A to about 1.6 mm in FIG. 3B to about 1 mm in FIG. 3C.

FIG. 3A has the highest aspect ratio (depth-to-width ratio) of the nugget 138 because it is the deepest in 3A and it is seen that in this example a substantial pore 140 was trapped within the weld nugget 138 as it was solidifying. A laser produced weld in which the aspect ratio of the weld nugget 138 is as high as in FIG. 3A leads to the formation of a substantial pore 140. In FIG. 3B, the depth of nugget 138 is less than in FIG. 3A but a pore 140 is still formed in the molten metal as it solidifies and this weld environment also produces a porous nugget. However, in FIG. 3C the depth to width ratio is considerably less than 1 and in this example there was enough molten metal at the sides of the original pool to permit the escape of all keyhole forming material. The resulting solidified nugget 138 in the example of FIG. 3C is pore free.

FIGS. 3D-3F are graphs similar to those in FIGS. 3A-3C. In these examples the depth of the molten metal pool comprising molten metal and keyhole material as evidenced by the depth of nugget 138 is constant at about 1.5 mm. But the width of the original molten metal pool, as evidenced by the width of nugget 138 in this model, increases from about 1.5 mm in FIG. 3D to about 1.6 mm in FIG. 3E to about 2 mm in FIG. 3F. FIGS. 3D-3F illustrate that the progressive increase in the width or diameter of the molten metal material/keyhole at constant depth results in a decreasing aspect ratio. With this experimental determination of a suitable weld pool aspect ratio, FIG. 3F, a pore free weld nugget 138 is made. But the higher aspect ratio examples of FIGS. 3D and 3E contain pores 140.

Thus, in the establishment of welding set-up parameters for a particular welding job, an important feature of the set-up work is to determine a suitable range of ratios of the depth of molten metal pool to the width of molten metal pool that will produce pore free welds, such as those illustrated in FIGS. 3C and 3F.

FIG. 4 is a process flow diagram for utilizing the FIGS. 3A-3F insights which permit the formation of pore-free laser generated welds. The process proceeds from start box 400 to pre-welding set-up operations commencing with process step box 402. In step 402, the welding job is initially specified with the selection of workpiece materials, such as aluminum alloy sheet material or ferrous metal alloy sheet material, and sheet thicknesses. At step 404, a suitable weld nugget penetration depth is determined for the assembly to be welded. These values are typically determined in millimeters. For example, if two 1 mm sheets of aluminum alloy are to be welded together, a suitable weld depth may be 1.2 mm for overlapping pieces.

Process step 406 comprises the selection of a suitable welding laser, such as a carbon dioxide laser, and laser operating parameters. Past experience suggests a certain starting point for the setting of laser power and the speed at which the laser beam is advanced over the workpiece and the diameter and location of the focal point of the laser beam. These variables are established by experience and/or experiment and/or modeling.

Process steps 402, 404, and 406 are preliminary to the startup of a welding line in which successive welding operations are performed on like workpieces.

Preparation for process step 408 is also done prior to the beginning of welding operations. Process step 408 comprises the continual monitoring of the weld pool depth and width as welding operation proceeds. As described above, this step is accomplished using suitable EMR detection and imaging instruments and a programmed computer for real time analysis of molten metal/keyhole geometry and on-the-run control of laser beam welding power and speed of advance and focusing of the laser beam. For example, a suitable infrared camera is used to visualize and image the width of the molten metal pool as it is formed by the laser beam at the weld site. Similarly infrared radiation and/or ultraviolet radiation is detected, as suggested, by the imaging device 44 in FIG. 1. This data, as is known, can be correlated quickly with the depth of the keyhole. Thus, measuring substantially instantaneous both the depth of the keyhole and the width of the molten metal online monitoring of the weld process on a continuous basis is accomplished and the aspect ratio is calculated by dividing the depth by the width as indicated in block 408.

When welding operations are commenced, the on-the-run welding control process of this invention cycles between process box 408 and the following process step boxes using, for example, the suitably programmed computer 36 (FIG. 1). The current aspect ratio measurement acquired in process step 408 is tested in the computer against a predetermined target range of suitable aspect ratios for pore-free welding in query box 410.

If the current welding pool depth to diameter ratio is greater than the target range as indicated with a “yes” answer in query box 410, the control process proceeds to process box 412. Pursuant to the function of process box 412, laser power is reduced or the speed of advancement of the layer is increased, depending upon welding experience reflected in a process database, to produce a lower aspect ratio. Another fix for the high aspect ratio is to diffuse or redirect the focus of the weld beam to reduce its penetration and to widen the weld pool. Following the laser operating changes in box 412 the process cycles back to box 408 and the process is continually repeated throughout a welding operation.

In the event that the current measured aspect ratio is not greater than the target aspect ratio range (“no” in query box 410), the programmed computer proceeds to query box 414. In box 414 the current measured aspect ratio is tested to see if it is less than the target aspect ratio range. If the test in box 414 produces a “yes” answer, the process proceeds to box 416. If the aspect ratio test in box 414 produces a “no” answer the process proceeds to box 418.

In the event that the weld pool depth to diameter ratio is less than the desired target range (“yes” in box 414), the power is increased or the welding speed is reduced as indicated in block 416. Alternatively, or concurrently, the focus of the weld beam may be sharpened redirected. The process cycles from box 416 to box 408 and the monitoring process repeats.

When the current process reaches box 418 the welding is producing a weld pool with a measured aspect ratio within the pre-determined range for pore-free welds. No changes are required in current welding parameters. The present weld parameters are maintained and the process loops to process box 408 in which the next monitoring cycle begins and the aspect ratio is continually measured and calculated.

The on-the-run monitoring and laser operating parameter adjustment determinations are repeated each 100 millisecond interval or so (for example) during the welding of a workpiece or succession of pieces. Thus, the practice of laser welding is enhanced by continual measurement of the width of the molten metal pool and the depth of the keyhole and molten metal and the maintenance of these dimensions within a specified aspect ratio range to obtain substantially pore-free welds.

While the invention has been described in terms of preferred embodiments, it will be appreciated that other forms of the process could be radially adapted by one skilled in the art. The scope of the invention is intended to be limited only by the following claims.

1. A method of forming a weld nugget in a metal workpiece when the weld nugget is made by directing a laser beam against a surface of the workpiece and moving the beam relative to the workpiece in a predetermined weld path, the power level of the laser beam, the focus of the laser beam and the speed of movement of the beam relative to the workpiece each being controllable, the method comprising:
predetermining a minimum weld pool depth from the workpiece surface to produce a weld nugget for the welding of the workpiece:
predetermining at least the power level, focus and speed of movement of the laser with respect to the material and the predetermined minimum weld nugget depth to produce a weld pool for the weld nugget, the weld pool having a depth to width-at-workpiece-surface ratio range for a pore-free nugget;
commencing welding at the predetermined laser power level, focus and speed and during the welding continually determining the depth and width of the weld pool; and
adjusting at least one of the power level, focus, or speed of the laser when the minimum weld pool depth is not attained or when the predetermined depth to width ratio range is not attained.

2. The method of forming a weld nugget in a workpiece as recited in claim 1 comprising reducing laser power when the determined weld pool depth-to-diameter ratio is greater than the predetermined ratio range.

3. The method of forming a weld nugget in a workpiece as recited in claim 1 comprising increasing laser speed when the determined weld pool depth-to-diameter ratio is greater than the predetermined ratio range.

4. The method of forming a weld nugget in a workpiece as recited in claim 1 comprising increasing laser power when the determined weld pool depth-to-diameter ratio is less than the predetermined ratio range.

5. The method of forming a weld nugget in a workpiece as recited in claim 1 comprising reducing laser speed when the determined weld pool depth-to-diameter ratio is greater than the predetermined ratio range.

6. The method of forming a weld nugget in a workpiece as recited in claim 1 comprising:
optically directing the laser beam perpendicular to the surface of the workpiece and gathering radiation from the weld site coaxial with the laser beam for sensing and determining the depth of the weld pool.

7. The method of forming a weld nugget in a workpiece as recited in claim 6 in which the radiation for sensing and determining the depth of the weld pool is infrared radiation.

8. The method of forming a weld nugget in a workpiece as recited in claim 1 comprising:
optically directing the laser beam perpendicular to the surface of the workpiece and gathering infrared radiation from the weld site at an oblique angle with respect to the laser beam for sensing and determining the width of the weld pool.

9. The method of forming a weld nugget in a workpiece as recited in claim 1 comprising:
optically directing the laser beam perpendicular to the surface of the workpiece and gathering radiation from the weld site coaxial with the laser beam for sensing and determining the depth of the weld pool; and simultaneously
gathering radiation from the weld site at an oblique angle with respect to the laser beam for sensing and determining the width of the weld pool.

10. The method of forming a weld nugget in a workpiece as recited in claim 1 comprising:
optically directing the laser beam perpendicular to the surface of the workpiece and gathering infrared radiation from the weld site coaxial with the laser beam for sensing and determining the depth of the weld pool; and, simultaneously
gathering infrared radiation from the weld site at an oblique angle with respect to the laser beam for sensing and determining the width of the weld pool.
